(19) United States
(12) Patent Application Publication
(10) Pub. No.: US 2002/0013727 A1
(43) Pub. Date: Jan. 31, 2002

(54) System for advertising on a network by displaying guide codes

(76) Inventor: Seong Ryul Lee, Seoul (KR)

Correspondence Address: eFirm, Ltd., 1725 DeSales St., N.W., Washington, DC, 20036, US

(21) Appl. No.: 09/778,736

(22) Filed: Feb. 8, 2001

(30) Foreign Application Priority Data
Jul. 27, 2000 (KR) 2000-43263

(51) Int. Cl. G06F 17/60

(52) U.S. Cl. 705/14; 705/26; 705/1

(57) ABSTRACT

An advertising method on a network comprises displaying a guide code corresponding to a network address of an advertisement object and allowing a user to transmit said guide code. Moreover, an advertisement method on a network for additionally allows a user to purchase an advertised good or service by transmitting a guide code via a mobile telephone and charging the cost of the purchase to a calling account of the mobile telephone. Also, the present invention has particular application as an advertisement guide system and method using guide codes, wherein users are able to simply and conveniently recollect Internet homepage addresses of advertisers of advertisements made through various advertisement media, using voice or character mailboxes or electronic mails of mobile communication terminals, without having to write down the Internet homepage addresses on a memo paper. The invention further relates to a simple reservation, purchase and settlement system that takes advantage of the rapid increase in the number of users of mobile communication terminals.

This application is related to and claims priority from Korean Patent Application No. 2000-43263, filed Jul. 27, 2000, which is incorporated herein by reference in its entirety.

### BACKGROUND OF THE INVENTION

1. Technical Field

The present invention relates to an advertising method on a network, comprising displaying a guide code corresponding to a network address of an advertisement object and allowing a user to transmit said guide code. Moreover, the present invention relates to an advertisement method on a network for additionally allowing a user to purchase an advertised good or service by transmitting a guide code via a mobile telephone and charging the cost of the purchase to a calling account of the mobile telephone.

The present invention has particular application as an advertisement guide system and method using guide codes, wherein users are able to simply and conveniently recollect Internet homepage addresses of advertisers of advertisements made through various advertisement media, using voice or character mailboxes or electronic mails of mobile communication terminals, without having to write down the Internet homepage addresses on a memo paper. The present invention further relates to a simple reservation, purchase and settlement system that takes advantage of the rapid increase in the number of users of mobile communication terminals.

2. Description of the Related Art

With the development of Internet business, a considerable part of commerce and information services have recently been provided on the Internet. Success or failure of businesses such as electronic commerce and information provision services on the Internet is chiefly dependent upon how much they are able to expose their Websites to Internet users and to have the users be impressed with the Websites, which means that the competitiveness of Internet business depends significantly on the publicity of the Websites.

As in conventional marketing, advertisements for Websites can be provided through mass media such as newspapers or broadcasts, signboards on streets, the interiors of public/mass transportation means, etc.

In particular, advertisements installed in the interior of mass transportation means such as buses, trains or subway trains may have a great advertising effect on passengers around them. In such a mass transportation setting, passengers may acquire desired information from advertisements provided by advertisers.

However, because too many advertisements are encountered in daily life, it is not easy for general people to recollect the contents of a specific advertisement later.

On the other hand, since the main object of such advertisements is to impress passengers with the Internet address of their associated Website, to increase the number of visitors to their Website, and to invite the visitors to register as members of their Website, the contents of such advertisement may have a stimulating character resulting in side effects such as various social problems and unpleasant feelings of the passengers.

Recently, so as to arouse the interests in associated Internet advertisements, advertisers have induced the Internet users to visit their Websites by presenting gifts or premiums. This advertising method is classical, but effective in its own way. However, persons wishing to visit a Website of a specific advertiser are mostly depending on their memories in recollecting the Internet address of the Website, but it is rare that they later accurately recollect the Internet address of the Website when in front of their computers.

Persons can gain direct access to a homepage of a specific advertiser in a radio Internet access manner using mobile communication terminals. In this case, users of mobile communication terminals have to personally enter an Internet domain name of the specific advertiser in a uniform resource locator (URL) box using buttons of their mobile communication terminals.

However, this operation is very complicated and inconvenient to the users. In order to solve this problem, a radio Internet service company creates menus linked to Websites of information providers or advertisers and displays the created menus sequentially on a display window of a mobile communication terminal of a certain user. If the user selects a menu of a desired Website among the displayed menus using his or her mobile communication terminal, then the radio Internet service company connects the mobile communication terminal to the Website of the selected menu.

However, the above-mentioned radio Internet access service system is not uniform and not compatible among radio Internet communication companies because each company defines codes, order, arrangement, etc. of Internet information and service provision site menus in its own way. As a result, Internet users encounter the inconvenience that they should have every knowledge of radio Internet service methods of all communication companies.

Furthermore, customers have to pass through complex online procedures such as entry of card numbers, passwords and resident registration numbers, etc. in order to purchase advertised merchandises or reserve them for purchase and settle their accounts for purchasing prices. In following these procedures, there may be security problems in that the information about customers could flow out without customers' knowledge.

### SUMMARY OF THE INVENTION

An object of the present invention is to provide a method for advertising on a network, comprising displaying a guide code corresponding to a network address of an advertisement object and allowing a user to transmit the guide code instead of having to remember and key in a URL address as well as other commands, thus providing a more user friendly, easy, and effective method of advertising.

In one embodiment of the present invention, an advertisement method on a network comprises displaying a guide code corresponding to a network address of an advertisement object and allowing a user to transmit the guide code.

In another embodiment of the present invention, an advertisement method on a network comprises displaying a guide code corresponding to a network address of an advertisement object and allowing a user to transmit the guide code, wherein the network is wireless.

In another embodiment of the present invention, an advertisement method on a network comprises displaying a guide code corresponding to a network address of an advertisement object and allowing a user to transmit the guide code, wherein the network is the Internet.

In another embodiment of the present invention, an advertisement method on a network comprises displaying a guide code corresponding to a network address of an advertisement object and allowing a user to transmit the guide code, wherein the network comprises a mobile telephone.

In another embodiment of the present invention, an advertisement method on a network comprises displaying a guide code corresponding to a network address of an advertisement object and allowing a user to transmit the guide code, wherein the network address is a URL website address.

In another embodiment of the present invention, an advertisement method on a network comprises displaying a guide code corresponding to a network address of an advertisement object and allowing a user to transmit the guide code, wherein the advertisement object comprises information that an advertiser wants to advertise.

In another embodiment of the present invention, an advertisement method on a network comprises displaying a guide code corresponding to a network address of an advertisement object and allowing a user to transmit the guide code, wherein the advertisement object comprises information relating to an advertised good or service.

In another embodiment of the present invention, an advertisement method on a network comprises displaying a guide code corresponding to a network address of an advertisement object, allowing a user to transmit the guide code, and transmitting to the user the network address corresponding to the guide code transmitted by the user.

In another embodiment of the present invention, an advertisement method on a network comprises displaying a guide code corresponding to a network address of an advertisement object, allowing a user to transmit the guide code, and providing a benefit to the user who transmits the guide code.

In another embodiment of the present invention, an advertisement method on a network comprises displaying a guide code corresponding to a network address of an advertisement object, allowing a user to transmit the guide code, and transmitting an identity code identifying the user.

In another embodiment of the present invention, an advertisement method on a network comprises displaying a guide code corresponding to a network address of an advertisement object, allowing a user to transmit the guide code, wherein the advertisement object comprises information relating to an advertised good or service, and allowing the user to purchase the advertised good or service by inputting the guide code.

In another embodiment of the present invention, an advertisement method on a network comprises displaying a guide code corresponding to a network address of an advertisement object, allowing a user to transmit the guide code, wherein the advertisement object comprises information relating to an advertised good or service, transmitting an identity code identifying the user, and allowing the user to purchase the advertised good or service by inputting the guide code.

In another embodiment of the present invention, an advertisement method on a network comprises displaying a guide code corresponding to a network address of an advertisement object, allowing a user to transmit the guide code, wherein the network comprises a mobile telephone and wherein the advertisement object comprises information relating to a specific advertised good or service, allowing the user to purchase the advertised good or service, and charging the cost of the purchase of the advertised item to a calling account of the mobile telephone.

In another embodiment of the present invention, an advertisement apparatus on a network comprises means for displaying a guide code corresponding to a network address of an advertisement object and means for allowing a user to transmit the guide code.

In another embodiment of the present invention, a computer program stored on a computer-readable medium comprises the instructions of displaying a guide code corresponding to a network address of an advertisement object, and allowing a user to transmit the guide code.

Therefore, the present invention has been made in view of the above-noted problems in the related art, and it is an object of the present invention to provide an advertisement guide system and method using guide codes, wherein the guide codes linked to Websites of advertisers are assigned respectively to advertisements associated with the advertisers, and people are able to recollect Website addresses of their desired advertisements and advertisers using the associated guide codes and short-message mails, voice mails or electronic mails of mobile communication terminals.

It is another object of the present invention to provide an advertisement guide system and method using guide codes, wherein the guide codes are assigned respectively to advertising Websites and, for radio Internet access using mobile communication terminals, users of the mobile communication terminals can gain instant access to desired Websites by a simple operation of entering guide codes assigned to the desired Websites using numeral keys of their mobile communication terminals.

It is a further object of the present invention to provide an advertisement guide system and method using guide codes, wherein peoples are provided with complimentary services, for example, free-call time upon member registration, etc. so that they can have interests in the guide codes, thereby promoting the utilization of the guide codes on advertising sites.

It is another object of the present invention to provide an advertisement guide system and method using guide codes, wherein the guide codes are assigned respectively to goods or service items to be sold or to be provided at a specific Internet site, and customers can gain instant access to shopping malls of Websites selling or providing specific goods or services, without passing through complex intermediate access procedures, by a simple operation of entering guide codes assigned to the specific goods or services using numeral keys of their mobile communication terminals, so that providers of the specific goods or services can expect the sales of those goods or services to increase.

It is yet another object of the present invention to provide a goods/service reservation, purchase and settlement system using guide codes, wherein the guide codes are assigned respectively to goods or service items provided for online/offline reservations, and customers can readily reserve or purchase the provided goods or service items through a simple and convenient identity authentication procedure using their mobile communication terminals and settle their accounts for purchasing prices by paying them with call fees of the mobile communication terminals.

In accordance with one aspect of the present invention, the above and other objects can be accomplished by a provision of an advertisement guide method using guide codes, comprising: the first step of assigning the guide codes respectively to advertising columns of a plurality of advertisers, each of the guide codes being composed of numerals, and linking the guide codes respectively to Web addresses of advertising sites of the advertisers; the second step of upon perceiving a given one of the guide codes, allowing a user to gain access to a guide code server through a mobile communication service system using his or her mobile communication terminal and enter the given guide code in the terminal under the guidance of an automatic response service system; the third step of, when the given guide code is entered, searching a guide code database for Website address information corresponding to the entered guide code and sending the searched Website address information to a voice mailbox belonging to a telephone number of the mobile communication terminal of the user; and the fourth step of allowing the user to open the voice mailbox associated with the telephone number of his or her mobile communication terminal, extracting information stored in the voice mailbox and confirming a Web address of an advertising site corresponding to the given guide code on the basis of the extracted information.

In accordance with another aspect of the present invention, there is provided an advertisement guide system using guide codes, comprising: at least one mobile communication terminal connected to a mobile communication service system over a radio communication network; an automatic response service system connected to the mobile communication service system for sending guide code entry guide information to the mobile communication terminal in a mode of entering a guide code, inserted in a given advertisement, using the mobile communication terminal; a guide code database for storing information about Web addresses of advertising sites of a plurality of advertisers; a server for extracting information about a Web address of an advertising site of an advertiser corresponding to the specific guide code from the guide code database when a user enters information containing the specific guide code using the mobile communication terminal under the guidance of the automatic response service system and then generating short-message information based on the extracted Website address information; and a mailbox service system connected to the mobile communication service system for storing the short-message information from the server in a mailbox belonging to a telephone number of the mobile communication terminal and reproducing the stored short-message information for user's confirmation.

### BRIEF DESCRIPTION OF THE DRAWINGS

The aforementioned aspects and other features of the invention will be explained in the following description, taken in conjunction with the accompanying drawings wherein:

FIG. 1 is a flow chart diagram illustrating an embodiment of the present invention;

FIG. 2 is a flow chart diagram illustrating another embodiment of the present invention;

FIG. 3 is a flow chart diagram illustrating another embodiment of the present invention;

FIG. 4 is a flow chart diagram illustrating another embodiment of the present invention;

FIG. 5 is a flow chart diagram illustrating another embodiment of the present invention;

FIG. 6 is a flow chart diagram illustrating another embodiment of the present invention;

FIG. 7 is a flow chart diagram illustrating another embodiment of the present invention;

FIG. 8 is a flow chart diagram illustrating another embodiment of the present invention;

FIG. 9 is a flow chart diagram illustrating another embodiment of the present invention;

FIG. 10 is a flow chart diagram illustrating another embodiment of the present invention;

FIG. 11 is a flow chart diagram illustrating another embodiment of the present invention;

FIG. 12 is a flow chart diagram illustrating another embodiment of the present invention;

FIG. 13 is a flow chart diagram illustrating another embodiment of the present invention;

FIG. 14 is a flow chart diagram illustrating another embodiment of the present invention;

FIG. 15 is a flow chart diagram illustrating another embodiment of the present invention;

FIG. 16 is a functional block diagram of a guide code-based advertisement guide system in accordance with an embodiment of the present invention;

FIG. 17 is a flowchart illustrating a personal information pre-registration procedure for user's convenience in accordance with an embodiment of the present invention;

FIG. 18 is a flowchart illustrating a guide code-based advertisement guide procedure in accordance with an embodiment of the present invention;

FIG. 19 is a flowchart illustrating a guide code-based radio Internet access procedure in accordance with an embodiment of the present invention;

FIG. 20 is a flowchart illustrating a guide code-based reservation, purchase and settlement procedure in accordance with an embodiment of the present invention;

FIG. 21 is a view showing an example of an advertisement into which a guide code is inserted in accordance with an embodiment of the present invention; and

FIG. 22 is a view illustrating a state where an Internet address of an advertiser is displayed on a display window of a user's mobile communication terminal through a short-message mailbox service in accordance with an embodiment of the present invention.

### DETAILED DESCRIPTION

The present invention will be described in detail, with reference to the accompanying drawings.

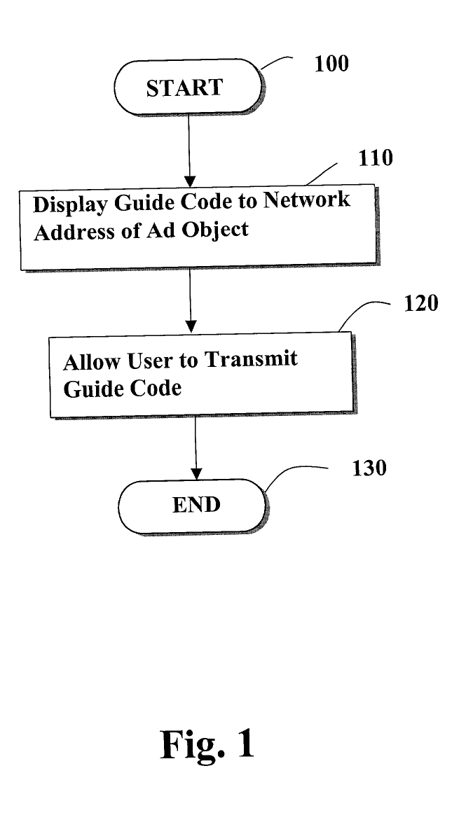

FIG. 1 shows a flow chart exemplifying an embodiment according to the present invention. An advertisement method on a network comprises displaying a guide code corresponding to a network address of an advertisement object at step 110 and allowing a user to transmit the guide code at step 120.

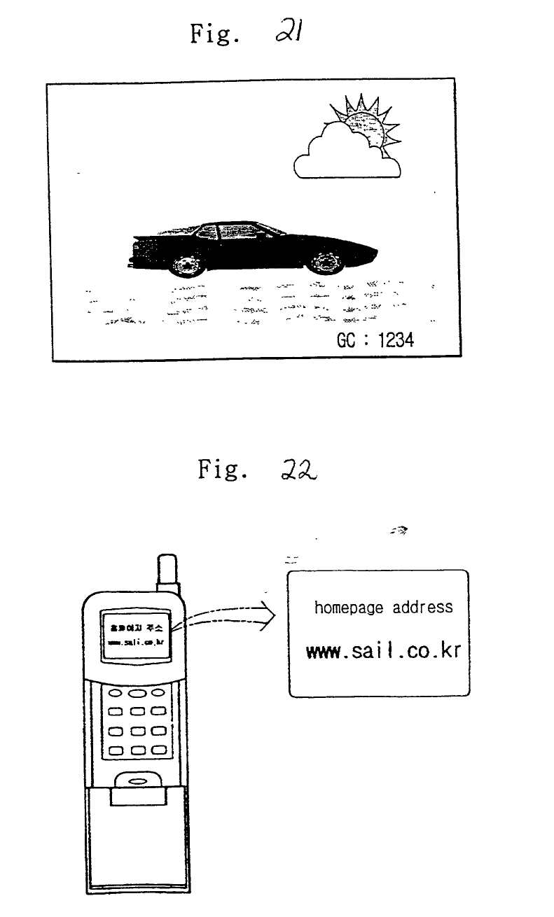

Just as an example, if this embodiment were applied to a mobile telephone operating via wireless Internet, the guide code corresponding to a network address of an advertisement object would be displayed on the display portion of the mobile telephone, as illustrated in FIG. 21. Since the guide code in this example is “1234,” the use may transmit the guide code by depressing in sequence the keys 1, 2, 3, and 4 on the mobile telephone. Since the guide code corresponds to a network address of an advertisement object, which in this case might be www.carsforsale.com with the advertisement object being the car shown on the display of the mobile telephone, transmitting the guide may, for example, lead to the user being able to access the website, the user being provided with the website address, or the user being able to purchase the car.

Of course, the network may be the Internet, an Intranet, or another type network. Also, the guide codes may be composed of numerous, as in the example above, or may consist of other characters, as well. In general, the guide codes will either be shorter or otherwise easier or efficient to use than a URL website address, but certainly, a guide code can take any form, style, or other characteristics so long as it corresponds to a network address. The network address, includes but is not limited to, the URL website address. The advertisement object can be, for example, a specific good or service or the website of an advertiser, or any other type of item that is being advertised. Transmitting the guide code, includes but is not limited to a user pushing keys on the mobile telephone and somehow transmitting the signals corresponding to the key inputs to another location, including but not limited to, the website of the advertiser. Of course, the signals could be transmitted to any suitable location (including, for example, within the mobile telephone itself).

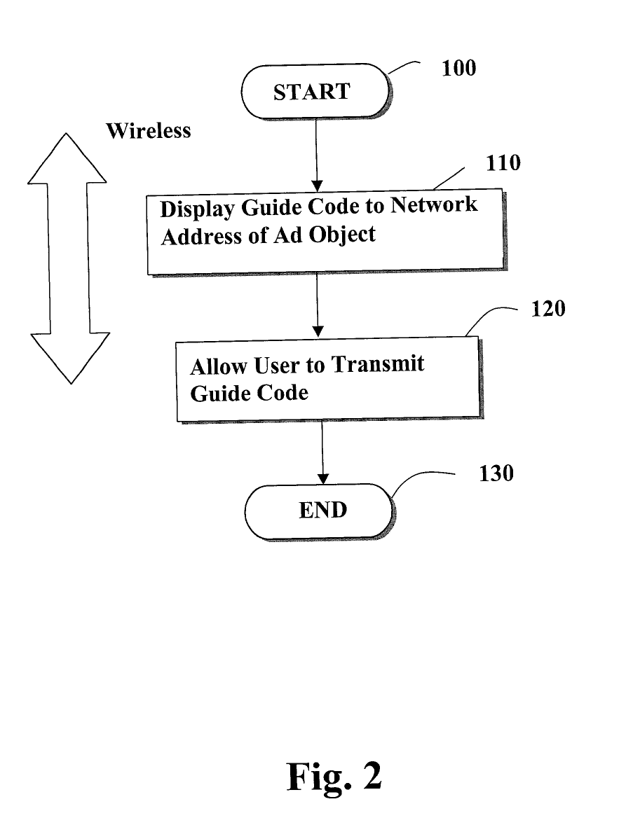

In another embodiment of the present invention, as exemplified by FIG. 2, an advertisement method on a network comprises displaying a guide code corresponding to a network address of an advertisement object at step 110 and allowing a user to transmit the guide code at step 120, wherein the network is wireless.

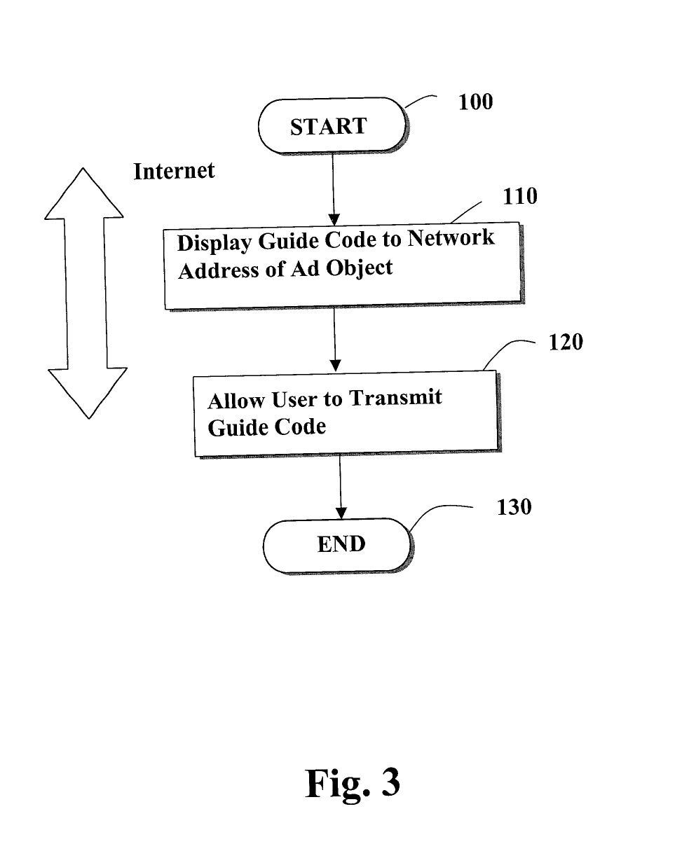

In another embodiment of the present invention, as exemplified by FIG. 3, an advertisement method on a network comprises displaying a guide code corresponding to a network address of an advertisement object at step 110 and allowing a user to transmit the guide code at step 120, wherein the network is the Internet.

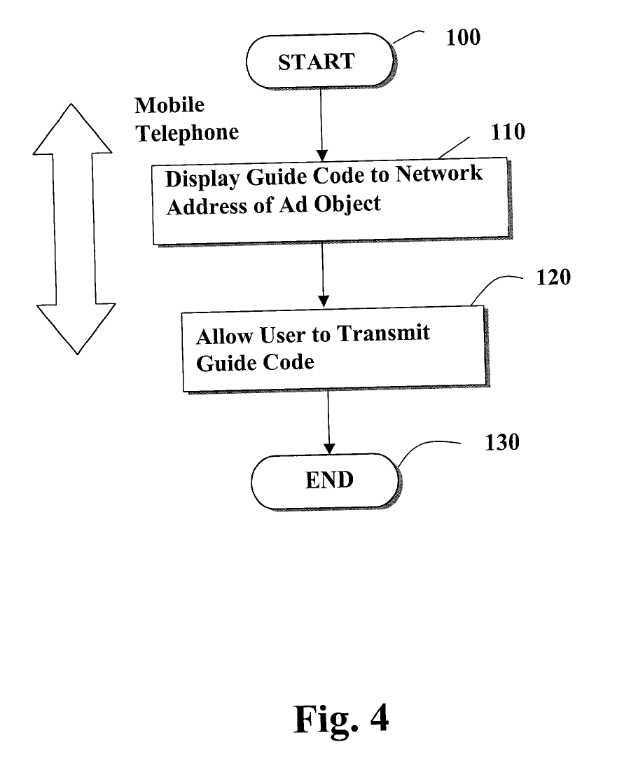

In another embodiment of the present invention, as exemplified by FIG. 4, an advertisement method on a network comprises displaying a guide code corresponding to a network address of an advertisement object at step 110 and allowing a user to transmit the guide code at step 120, wherein the network comprises a mobile telephone.

Of course, a mobile telephone, includes but is not limited to, hand phones, cell phones, car phones, and any other form of communication that the user can use while traveling from one place to another.

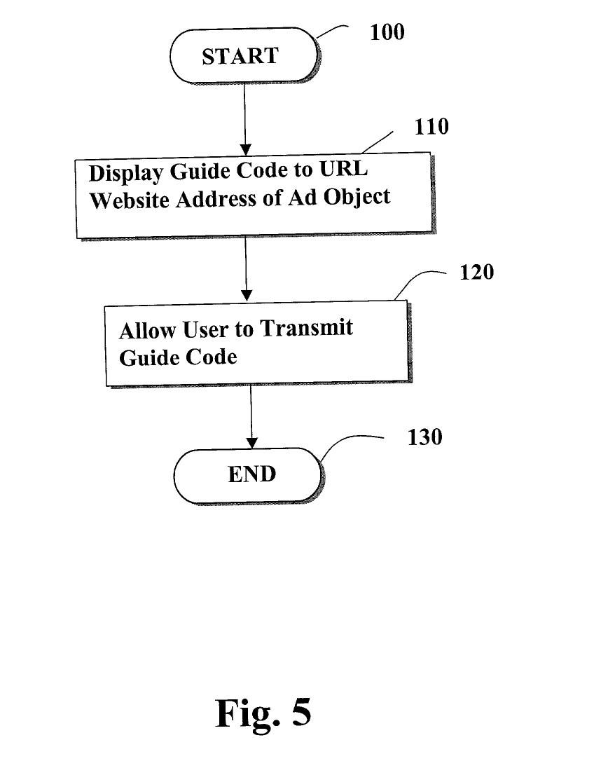

In another embodiment of the present invention, as exemplified by FIG. 5, an advertisement method on a network comprises displaying a guide code corresponding to a network address of an advertisement object at step 110 and allowing a user to transmit the guide code at step 120, wherein the network address is a URL website address.

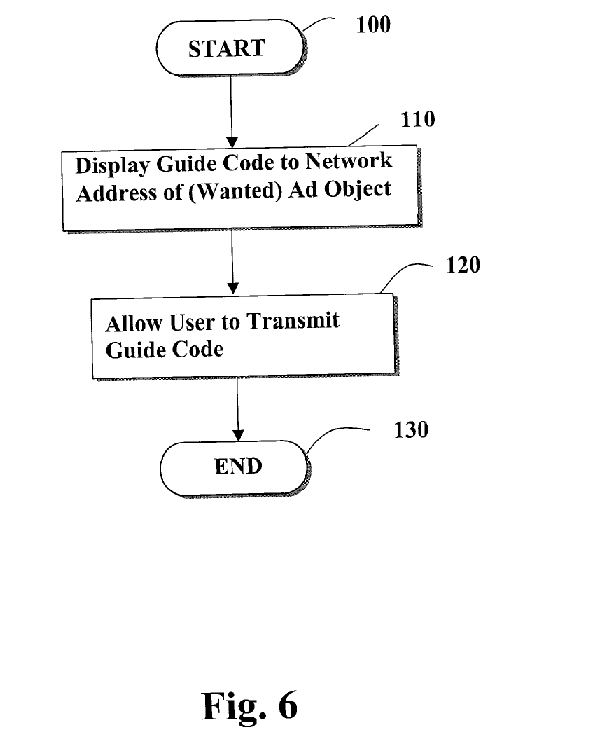

In another embodiment of the present invention, as exemplified by FIG. 6, an advertisement method on a network comprises displaying a guide code corresponding to a network address of an advertisement object at step 110 and allowing a user to transmit the guide code at step 120, wherein the advertisement object comprises information that an advertiser wants to advertise.

Of course, the type, quantity, or other characteristic of the information is virtually infinite, but may include, for example, the homepage of the advertiser or the price and size of a painting.

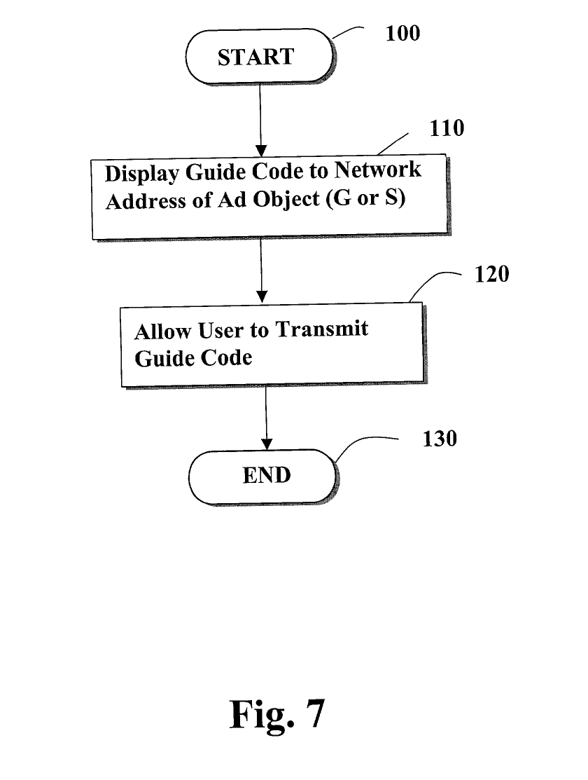

In another embodiment of the present invention, as exemplified by FIG. 7, an advertisement method on a network comprises displaying a guide code corresponding to a network address of an advertisement object at step 110 and allowing a user to transmit the guide code at step 120, wherein the advertisement object comprises information relating to an advertised good or service.

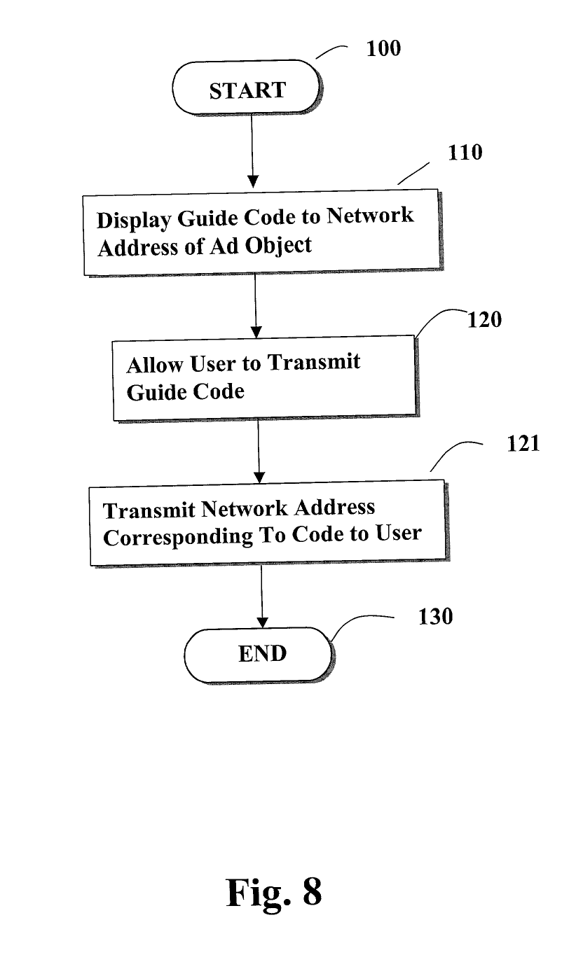

In another embodiment of the present invention, as exemplified by FIG. 8, an advertisement method on a network comprises displaying a guide code corresponding to a network address of an advertisement object at step 110, allowing a user to transmit the guide code at step 120, and transmitting to the user the network address corresponding to the guide code transmitted by the user at step 121.

Just as an example, after a user pushes the keys of the mobile telephone for the guide code and transmits the receiving party then can transmit back to the user's mobile telephone the corresponding website address, as illustrated in FIG. 22.

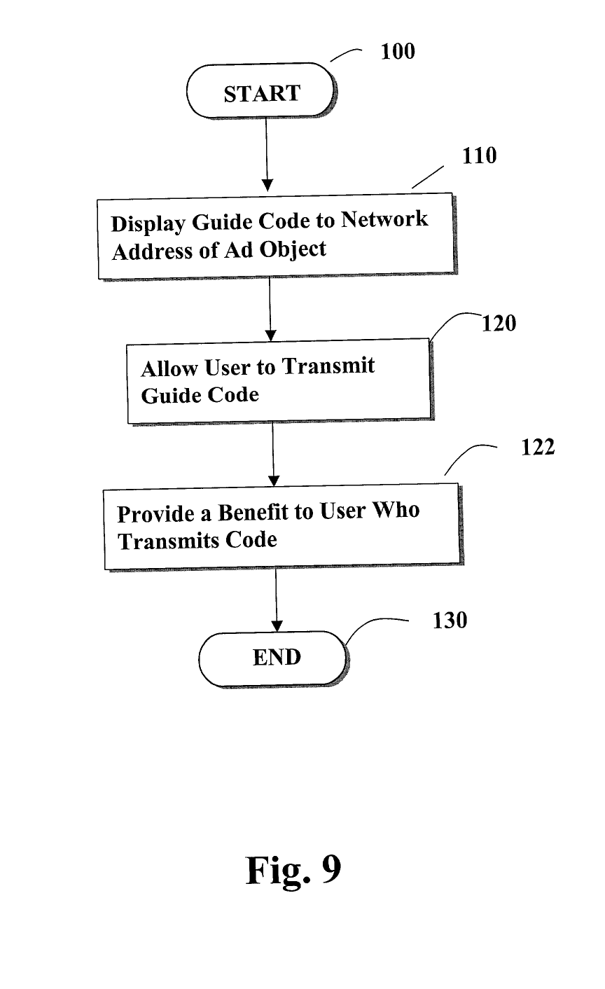

In another embodiment of the present invention, as exemplified by FIG. 9, an advertisement method on a network comprises displaying a guide code corresponding to a network address of an advertisement object at step 110, allowing a user to transmit the guide code at step 120, and providing a benefit to the user who transmits the guide code at step 122.

As explained further below, the benefit could include but is not limited to cyber-cash, prizes, free call time, information, and any other item that could be beneficial to the user.

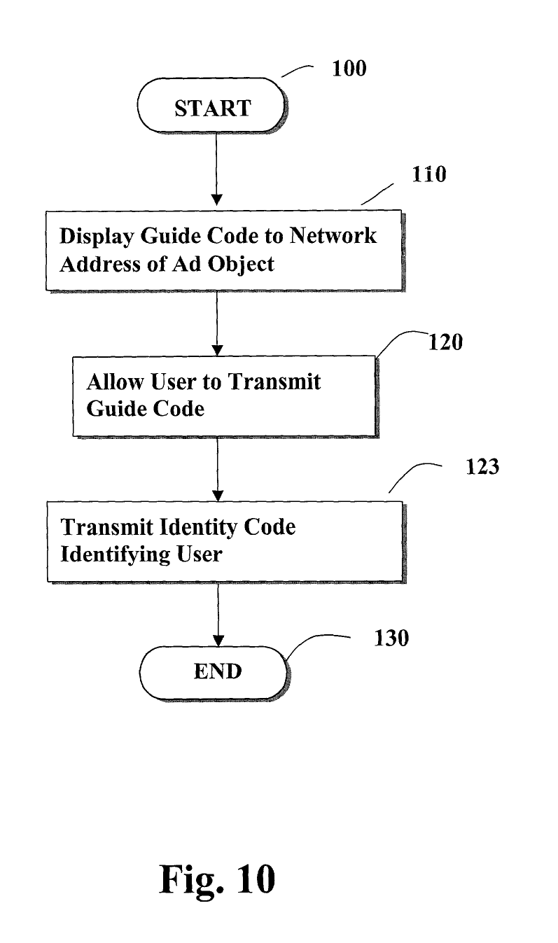

In another embodiment of the present invention, as exemplified by FIG. 10, an advertisement method on a network comprises displaying a guide code corresponding to a network address of an advertisement object at step 110, allowing a user to transmit the guide code at step 120, and transmitting an identity code identifying the user at step 123.

The identity code may include but not is not limited information that the user input into the mobile telephone, or the customer information that the mobile telephone company can access, or any other suitable information. Also, the identity code may automatically be transmitted or the user can transmit.

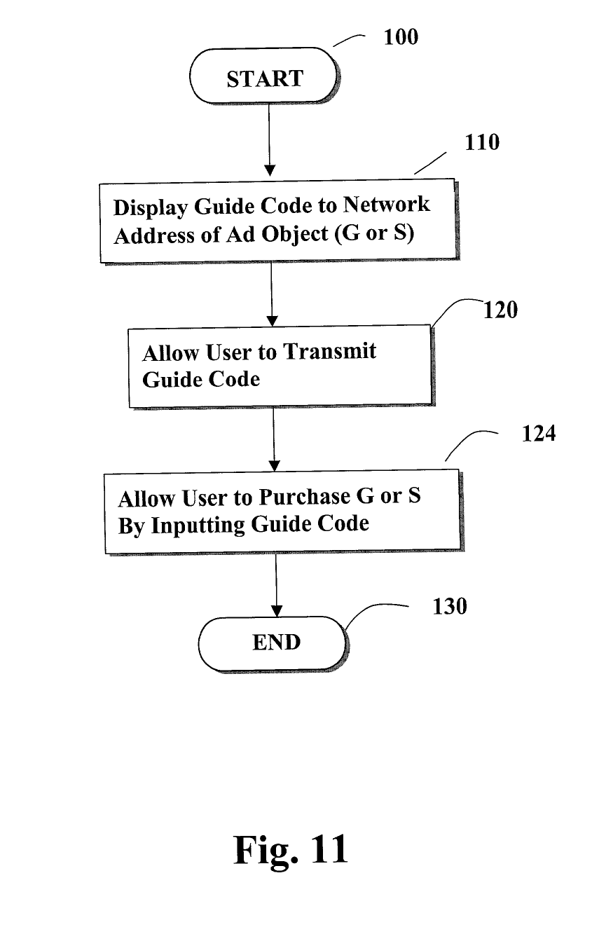

In another embodiment of the present invention, as exemplified by FIG. 11, an advertisement method on a network comprises displaying a guide code corresponding to a network address of an advertisement object at step 110, allowing a user to transmit the guide code at step 120, wherein the advertisement object comprises information relating to an advertised good or service, and allowing the user to purchase the advertised good or service by inputting the guide code at step 124.

Just as an example, inputting and transmitting the guide code will notify the seller or the receiving party that the user wants to purchase the good or service and the transaction can proceed. The seller charges the purchasing user in a suitable manner and the good or service can be delivered or otherwise be provided to the user.

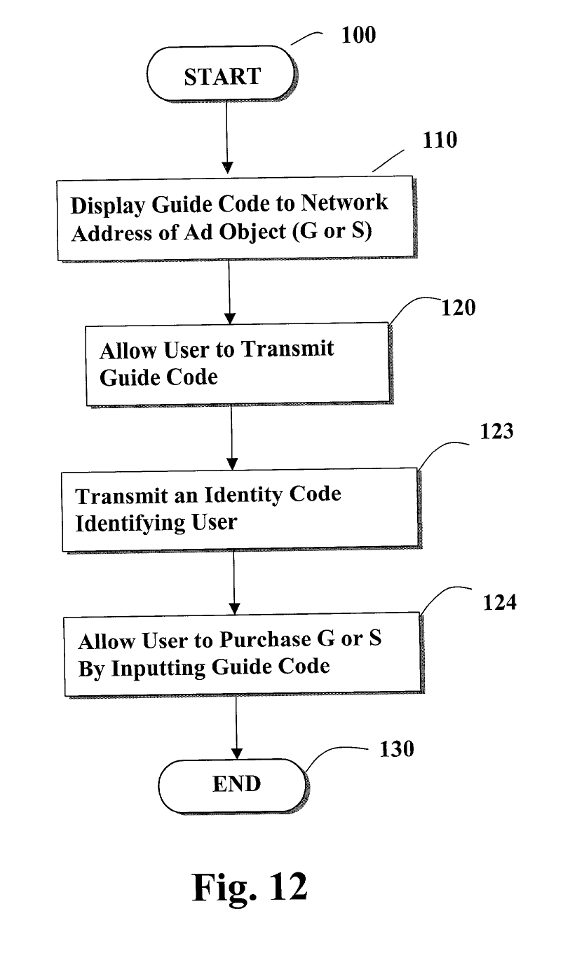

In another embodiment of the present invention, as exemplified by FIG. 12, an advertisement method on a network comprises displaying a guide code corresponding to a network address of an advertisement object at step 110, allowing a user to transmit the guide code at step 120, wherein the advertisement object comprises information relating to an advertised good or service, transmitting an identity code identifying the user 123, and allowing the user to purchase the advertised good or service by inputting the guide code at step 124.

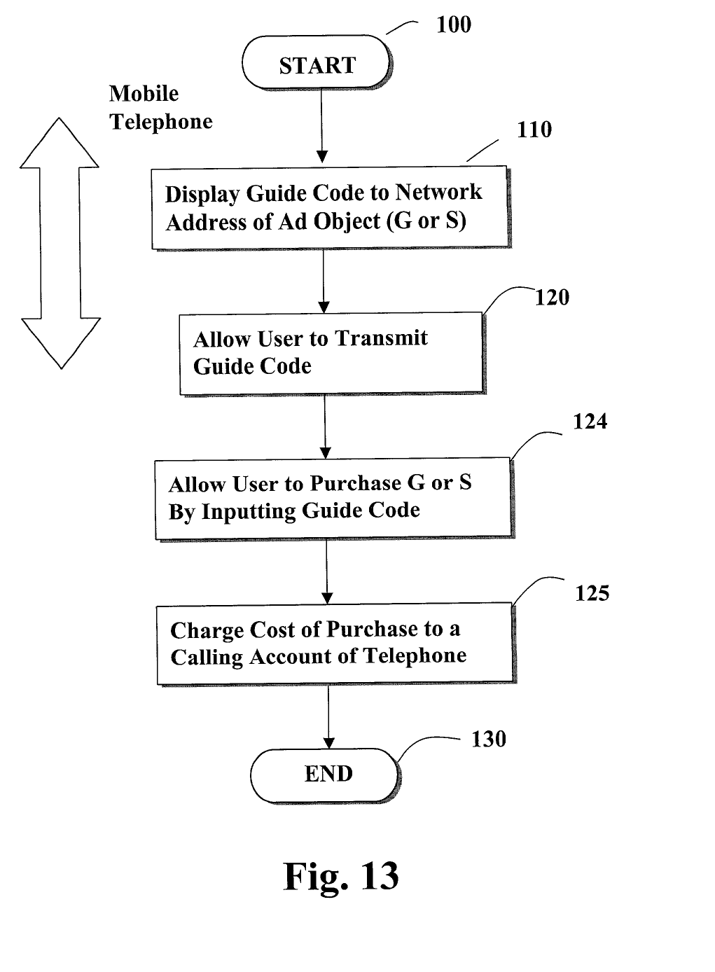

In another embodiment of the present invention, as exemplified by FIG. 13, an advertisement method on a network comprises displaying a guide code corresponding to a network address of an advertisement object at step 110, allowing a user to transmit the guide code at step 120, wherein the network comprises a mobile telephone and wherein the advertisement object comprises information relating to a specific advertised good or service, allowing the user to purchase the advertised good or service at step 124, and charging the cost of the purchase of the advertised item to a calling account of the mobile telephone at step 125.

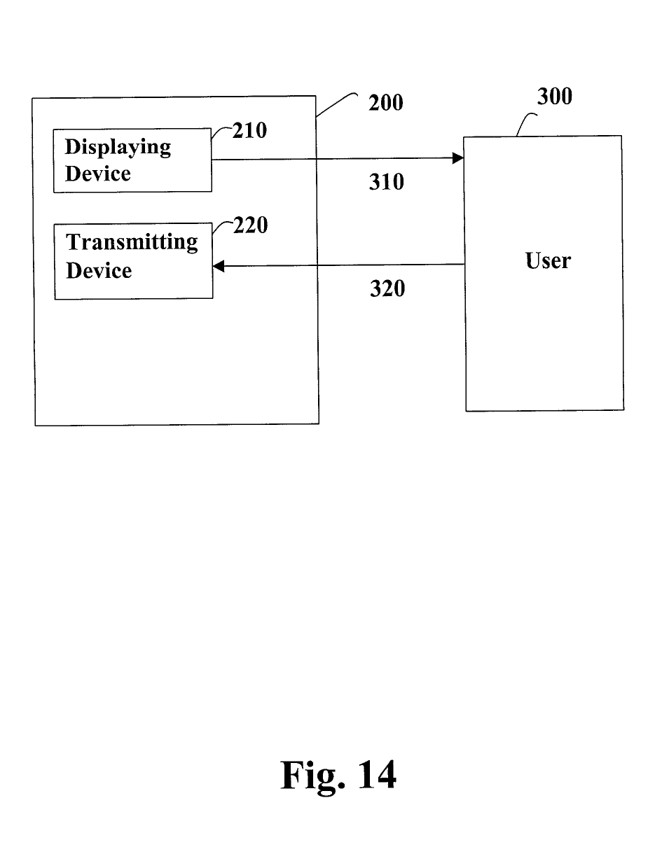

In another embodiment of the present invention, as exemplified by FIG. 14, an advertisement apparatus 200 on a network comprises means for displaying a guide code corresponding to a network address of an advertisement object or display device 210 and means for allowing a user to transmit the guide code or transmitting device 220. User 300 may transmit information to and from the displaying device and transmitting device via paths 310 and 320 (only two are shown, but a plurality of paths may be provided, as needed).

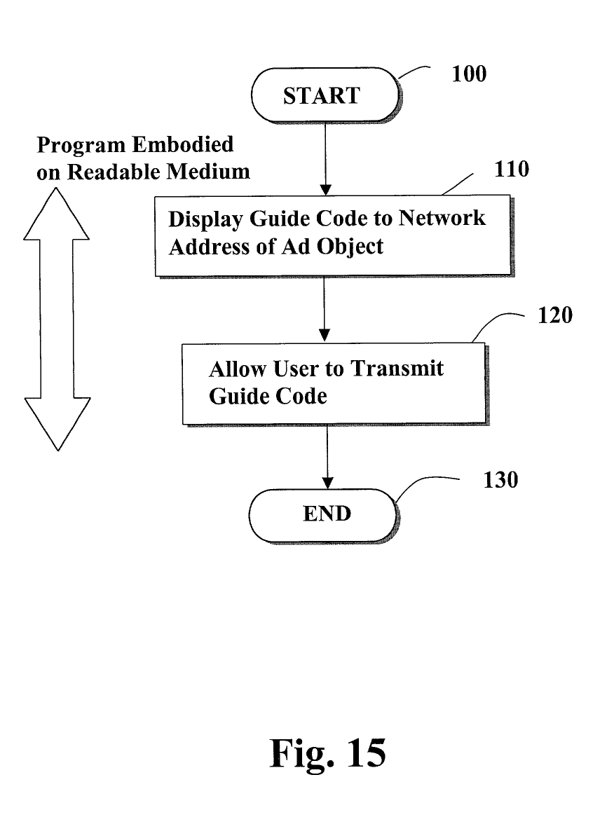

In another embodiment of the present invention, as exemplified by FIG. 15, a computer program stored on a computer-readable medium comprises the instructions of displaying a guide code corresponding to a network address of an advertisement object at step 110, and allowing a user to transmit the guide code at step 120.

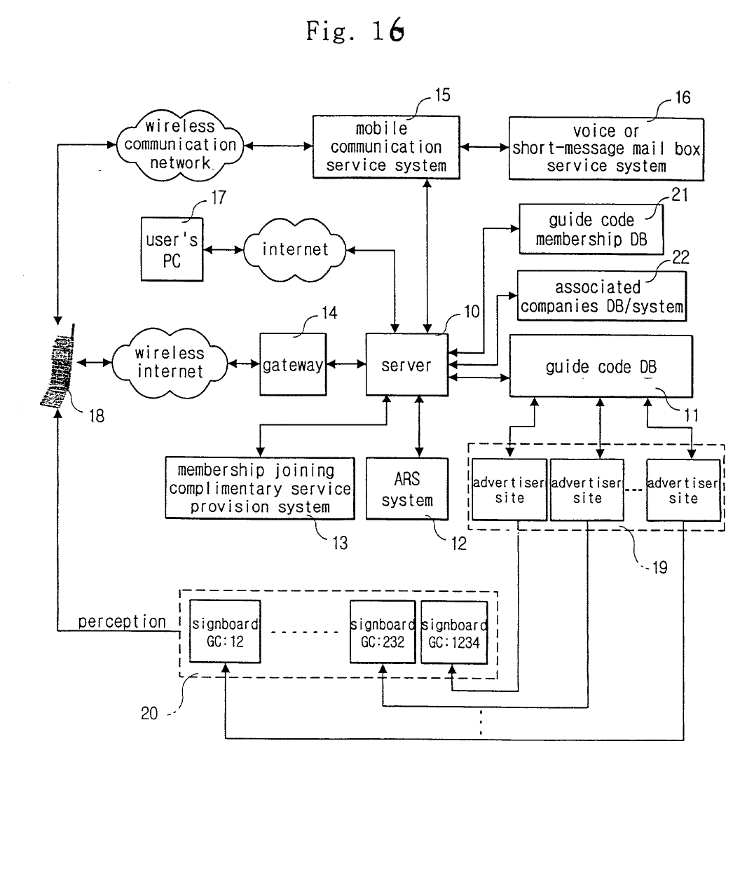

FIG. 16 is a functional block diagram of a guide code-based advertisement guide system in accordance with an embodiment of the present invention. With reference to FIG. 16, a mobile communication service system 15 managed by a mobile communication network service company is connected to a server 10 to provide a mobile communication terminal 18 with an automatic response service (ARS) and short-message (or voice) mailbox service for guide code entry, which originate from an ARS system 12 and mailbox service system 16, respectively.

A user's personal computer (PC) 17 is connected over a wired Internet network to the server 10. A gateway 14 is connected to the server 10. The mobile communication terminal 18 is connected to the server 10 over a radio Internet network and through the gateway 14.

A membership joining complimentary service provision system 13 and the ARS system 12 are also connected to the server 10. The membership joining complimentary service provision system 13 contains a program for providing a predetermined amount of mobile communication terminal free-call time or a predetermined amount of money and other valuables to customers joining membership using guide codes. The ARS system 12 contains an ARS program for automatically guiding entry order of a guide code, a telephone number, etc. in the mobile communication terminal 18 when an owner of the terminal 18 enters the guide code.

Also connected to the server 10 is a guide code database (DB) 11 which stores digital voice message information for guiding Website addresses corresponding respectively to guide codes. A plurality of advertiser sites 19 are connected to the guide code DB 11 to provide update information and link information to the DB 11.

On the basis of Website link information of a unique guide code assigned to each of the advertiser sites 19, a user of the mobile communication terminal 18 can gain access to an Internet site of a desired advertiser by performing a simple operation of entering the unique guide code.

The unique guide codes of the advertiser sites 19 are also marked on predetermined portions of signboards 20 of the sites 19, perceptible by the owner of the mobile communication terminal 18. Hence, customers can easily perceive the guide codes representing of the advertiser sites and enter them in their mobile communication terminals.

A guide code membership DB 21 for personal information pre-registration and associated companies DB/system 22 are also connected to the server 10. On the basis of registration information in the guide code membership DB 21, customers can automatically register as members of a plurality of Internet membership invitation companies by performing a one-click operation.

Now, a detailed description will be given of the operation of the guide code-based advertisement guide system with the above-mentioned construction in accordance with the present invention.

Provided that the user of the mobile communication terminal 18 encounters an advertisement for informing a specific service, goods or Website, he or she will have an interest in the contents of the advertisement. Then, the user of the mobile communication terminal 18 will find a guide code marked in the advertisement, which corresponds to a Website of an advertiser associated with the advertisement.

FIG. 21 shows an exemplary guide code marked on a predetermined portion of an advertisement, wherein the guide code is indicated by “GC: 1234”.

If a given advertisement has a certain guide code composed of numerals, as stated above, there is no doubt that it belongs to a membership advertiser registered in the advertisement guide system of the present invention. In order for the user of the mobile communication terminal 18 to firmly fix a Website of such an advertiser in his or her memory, he or she connects to the mobile communication service system 15, managed by a mobile communication service company with a unique connection number, using the mobile communication terminal 18 and then enters a guide code associated with the Website in the terminal 18, instead of memorizing a domain name of the Website.

Each mobile communication service company registered in the present advertisement guide system is assigned a unique connection number (for example, “*77*”) by the system. If there is a connection request from the user of the mobile communication terminal 18 through the unique connection number, then the ARS system 12 is run to inform the user of the mobile communication terminal 18 of entry order of a guide code inserted in a given advertisement.

If the user of the mobile communication terminal 18 enters a guide code inserted in a given advertisement under the guidance of the ARS system 12 to memorize a Website address of the given advertisement, then the server 10 searches the guide code DB 11 for Website address information corresponding to the entered guide code.

Then, the server 10 sends the Website address information corresponding to the entered guide code to the voice or short-message mailbox service system 16 of the mobile communication service system 15, which then stores the sent Website address information corresponding to the entered guide code in a mailbox belonging to a telephone number of the mobile communication terminal 18.

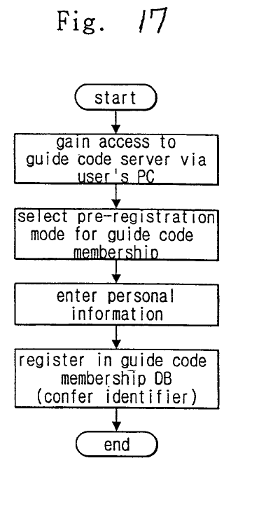

As exemplified in FIG. 17, one who wants to affiliate himself with the club, the society or the like at every advertising site on which a guide code is conferred, so as to enjoy the benefits included with the acquirement of the membership can connect with the server 10 via the user PC 17 to register his or her personal information in the guide code membership DB 21, in advance, in order to make the membership application procedure simple. That means, using this pre-registered personal information, the person can join a multitude of membership advertising sites at once by a one-click operation. Whether or not a mobile communication terminal user uses such a pre-registered information database in the membership application may be determined by entering a guide code alone or in combination with an identifier.

For instance, when a guide code tagged with an identifier is entered, the server 10 may recognize that the mobile communication terminal user requests the one-click application for membership in the advertising site corresponding to the guide code by use of the pre-registered guide code membership DB 21 and send the membership information to the advertising site of interest, serving as an agent for membership application.

On the other hand, in the absence of any identifier or when no personal information is pre-registered in the guide code membership DB 21, an advertisement or Website address of the advertiser company corresponding to the entered guide code may be stored in a voice or character mailbox or a pre-registered E-mail account designated by a telephone number of the user's mobile communication terminal.

As soon as a guide code is entered from a phone, an advertiser's website address or vocal advertisement corresponding to the guide code is sent to a voice or character mailbox or E-mail account designated by a number of the phone. On the whole, because the server 10 can acquire information about a telephone number of a currently connecting mobile communication terminal from the mobile communication service system 15, the telephone number may not be separately inputted when Website address information about the advertising guide code is sent to a mailbox or an Internet E-mail account of the mobile communication terminal.

However, when information about an advertising site of interest is required to be sent to a specific person, a mobile communication terminal number or E-mail address of the recipient should be inputted.

Turning to FIG. 22, there is an illustration of a mobile communication terminal and its display window through which a Website address stored in a character mailbox of the terminal, which corresponds to a guide code of an advertiser, is displayed.

Meanwhile, upon registering guide codes for any advertisements in a character or voice mailbox associated with a telephone number of a mobile communication terminal, a person can open the mailbox any time to recognize a domain name of a desired advertising site. Also, a person can gain knowledge of Web address information about an advertising site that has been sent from another person and stored in the mailbox of his or her phone number.

After confirming Website address information about advertisers, stored in a mobile communication terminal, a person who occupies the terminal can connect with advertising sites of interest by means of the user PC 17.

After recognizing an Internet site through an advertisement, an owner or user of a mobile communication terminal can confirm the site through a voice or short-message mailbox or an E-mail. When the owner enters an advertising site corresponding to the recognized Web address, a request for membership registration is offered together with various membership benefits, for example, a free-call service for a certain time period and a cash-back point acquired upon membership registration. Also, the maximum number of members who can enjoy the benefits upon membership registration is suggested.

When the person joins the site in response to the registration offer, the server determines whether the number of members who are enjoying the complimentary service reached the service beneficiary member limit that the advertiser predetermined. If the number is below the limit, the server provides the complimentary service (e.g., free-call service) while accepting the personal information and affiliating him or her with the advertising site.

On the other hand, where the number of preexisting members has reached or exceeded the contract limit that the advertiser predetermined, persons who apply for membership after recognizing the advertisement cannot enjoy the complimentary service such as the free-call service. In this case, the applicants must be informed that the complimentary service cannot be provided even if they become members.

With the aim of promoting the application for membership in its site, the advertiser offers complimentary services such as free-call services to a multitude of people who join the advertised club, society, etc.

Meanwhile, the use of such guide codes aids in popularizing the representation of addresses of Internet sites by numerals. Accordingly, people become familiar with the guide codes, through which they are able to obtain easy access to desired Websites.

Guide code-based Internet site connection will be very useful in WAP. Based on a menu-shifting system using directing keys for searching or registering Internet addresses, pre-existing WA-P suffers from the disadvantage that greater numbers of menus make the use of a wireless Internet network more complicated, requiring a longer period of time for connecting to a server.

However, customers can gain instant access to desired radio Internet sites by using guide codes proposed in the present invention.

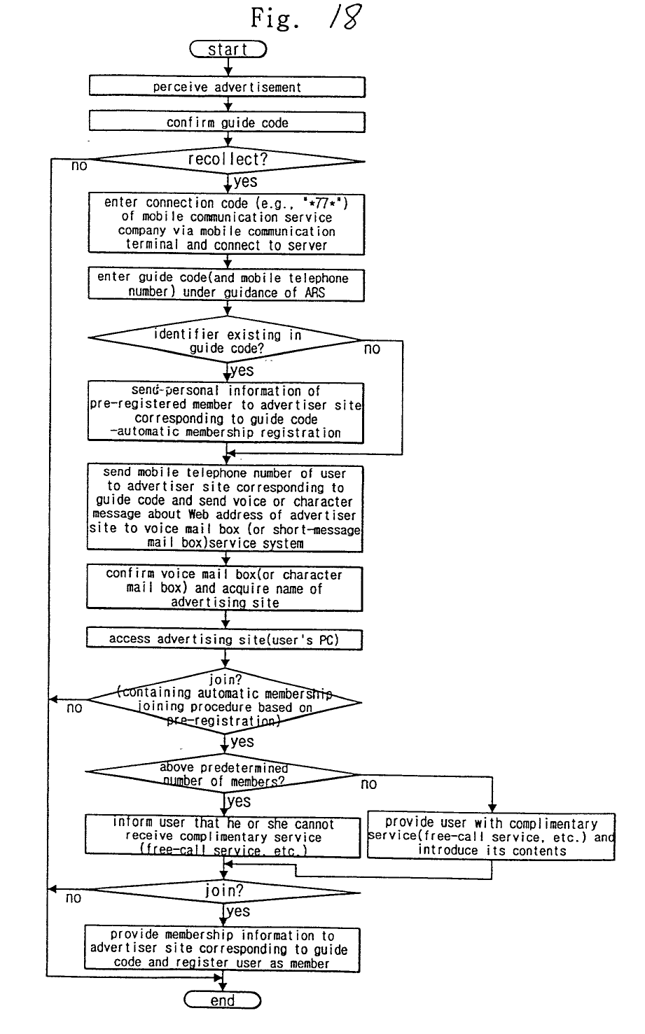

FIG. 18 is a flowchart illustrating a guide code-based advertisement guide procedure in accordance with the present invention.

With reference to FIG. 18, at the first step, the server of the guide code-based advertisement guide system of the present invention assigns a unique guide code composed of numerals to an advertisement column of each advertiser and links the assigned guide code to a Web address of an advertising site of a corresponding advertiser, thereby setting up conditions for users to simply access the advertising site using the guide code.

Preferably, guide codes are assigned unique numerals by advertisers. Also, each of the guide codes is assigned any one of sub codes by goods items of a corresponding advertiser or any one of sub codes by goods names of the corresponding advertiser so that it can function as a transaction code for a goods unit.

At the second step, upon perceiving a given guide code, a user of a mobile communication terminal connects the terminal to the guide code server and then enters a numeral array of the guide code in the terminal. At this time, the user may send the given guide code and information regarding a Website address of an advertiser corresponding to the guide code to a mailbox associated with a telephone number of a different person by entering the telephone number of the different person as well as his or her own telephone number in the mobile communication terminal.

At the third step, if the given guide code is entered, the server searches the guide code database for Web site address information corresponding to the entered guide code and sends the searched Website address information to a voice mailbox belonging to the telephone number of the mobile communication terminal of the user.

At the fourth step, the user opens the voice mailbox associated with the telephone number of his or her mobile communication terminal and extracts information stored in the voice mailbox. Then, the user confirms a Web address of an advertising site corresponding to the given guide code on the basis of the extracted information and gains access to the advertising site using his or her user PC.

At the fifth step, if the user gains access to the desired advertising site using his or her user PC, then he or she shifts to a membership-joining menu to execute a complimentary service-conditioned membership joining procedure. In the case where the user registers as a member of the advertising site, the advertiser may provide the user with various complimentary service items such as a predetermined amount of mobile communication terminal free call time, a predetermined amount of money and other valuables, etc.

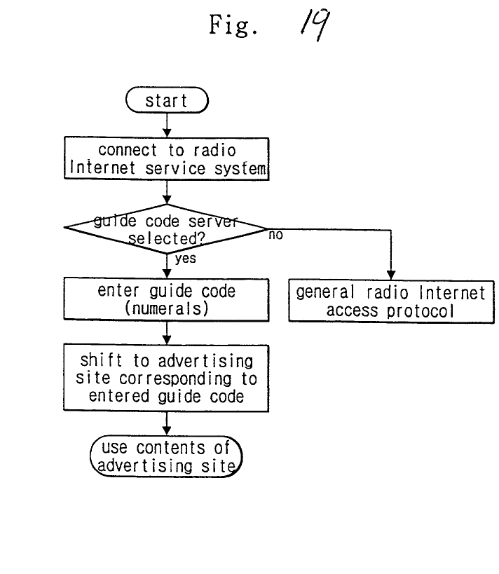

FIG. 19 is a flowchart illustrating a guide code-based radio Internet access procedure in accordance with the present invention.

With reference to FIG. 19, if a user of a mobile communication terminal connects to a radio Internet service system using his terminal, then a radio Internet access server inquires of the user about whether he or she will select a guide code-based radio Internet access mode.

If the user selects the guide code-based radio Internet access mode, or the guide code server, using his or her mobile communication terminal, then the guide code server is ready to input a guide code from the terminal of the user. Alternatively, in the case where the user does not select the guide code-based radio Internet access mode, the radio Internet access server applies a general radio Internet access protocol to the user.

Upon inputting the guide code from the mobile communication terminal of the user, the guide code server connects the terminal to a Website of an advertiser associated with the guide code. In this manner, the guide code server supports the user to perform the radio Internet access operation for a specific site by simply entering an associated guide code in his or her mobile communication terminal.

Preferably, a guide code assigned to each advertiser site may be appended with a given one of sub codes assigned respectively to items of goods being on sale in an associated advertising site, so that a customer can gain direct access to a site selling desired goods, over a radio Internet network, using a sub code corresponding to the desired goods in order to purchase the desired goods.

For example, assuming that a guide code assigned to a specific advertiser site has a basic code value of “12” and a sub code assigned to an item of goods or a service item being on sale in the advertising site has a code value of “19” or “356”, the entire guide code will have the form of “1219”, “12356”, “12-19” or “12-356”.

Such a sub code about a goods or service item can be inserted and marked in a signboard together with a guide code about an advertising site. Therefore, a user of a mobile communication terminal can gain direct access to a specific advertising site and register as a member of the advertising site by a simple operation of entering a guide code assigned to the advertising site using numeral keys of his or her mobile communication terminal. Further, the user can gain instant access to a service or goods provided in the specific advertising site using a sub code appended to the guide code.

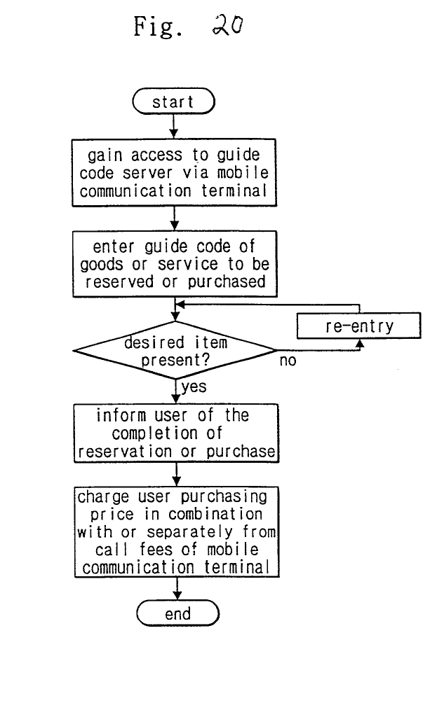

FIG. 20 is a flowchart illustrating a guide code-based reservation, purchase and settlement procedure in accordance with the present invention.

With reference to FIG. 20, first, a user of a mobile communication terminal gains access to the guide code server using his or her terminal to purchase a desired service or goods or reserve it for purchase. Then, if the user enters a guide code of the desired (reserved) goods or service in his or her mobile communication terminal, the guide code server displays names of goods (services) registered by a goods or service selling company on a display window of the terminal. If there is no desired one among items displayed on the display window of the mobile communication terminal, the user enters the guide code again in the terminal. Alternatively, in the case where a desired item exists among the items displayed on the display window of the mobile communication terminal, the user selects the desired item from among the displayed items and reserves or purchases the desired goods or service.

If the user reserves or purchases the desired goods or service, then the goods or service selling company notifies the guide code server of a purchasing price of the purchased goods or service and, in turn, the guide code server requests a mobile communication company associated with the mobile communication terminal of the user to charge the user the purchasing price in combination with or separately from call fees of the mobile communication terminal.

If the user pays the mobile communication company the purchasing price together with the call fees of the mobile communication terminal, then the mobile communication company transfers the paid purchasing price to the guide code server and, in turn, the guide code server pays the transferred purchasing price to the goods or service selling company. In this manner, a sequence of sale on commission is performed and completed.

Therefore, by assigning guide codes respectively to goods or services provided for reservation, customers can readily reserve or purchase desired goods or services without special transaction authentication procedures owing to the individualization of their mobile communication terminals. Further, customers can easily settle their accounts for purchasing prices by associating them with call fees of their mobile communication terminals, resulting in a reduction in settlement burden on advertisers.

As apparent from the above description, the present invention provides an advertisement guide system and method using guide codes, wherein the guide codes are linked respectively to Websites of advertisers and assigned respectively to advertisements associated with the advertisers, and a guide code management company guides a general person to a Website address of a specific advertiser through a mailbox service of a mobile communication terminal of the general person if this person enters guide code information corresponding to the specific advertiser in his or her mobile communication terminal. Therefore, the general person can simply and accurately recollect Web addresses of a plurality of advertising sites inserted in signboards using only his or her mobile communication terminal, without using a pen and memo paper to memorize the Web addresses one by one.

Further, for radio Internet access using mobile communication terminals, users of the mobile communication terminals can gain instant access to desired Websites by a simple operation of entering guide codes assigned to the desired Websites using numeral keys of their mobile communication terminals.

Further, guide codes can be assigned respectively to goods or service items to be sold or provided at a specific Internet shopping mall site, and customers can gain instant access to shopping malls of Websites selling or providing specific goods or services, without passing through complex intermediate access procedures, by a simple operation of entering guide codes assigned to the specific goods or services using numeral keys of their mobile communication terminals. Therefore, providers of the specific goods or services can expect the sales of those goods or services to increase.

Further, guide codes can be assigned respectively to goods or service items provided for reservation, and customers can readily reserve or purchase the provided goods or service items through a simple and convenient reservation or purchase system without special transaction authentication procedures owing to the individualization of their mobile communication terminals. Furthermore, customers can easily settle their accounts for purchasing prices by associating them with call fees of their mobile communication terminals, resulting in a reduction in settlement burden on advertisers.

Although the preferred embodiments of the present invention have been disclosed for illustrative purposes, those skilled in the art will appreciate that various modifications, additions and substitutions are possible, without departing from the scope and spirit of the invention as disclosed in the appended claims.

What is claimed is:

1. An advertisement method on a network, comprising:
displaying a guide code corresponding to a network address of an advertisement object;
allowing a user to transmit said guide code.

2. A method according to claim 1, wherein said network is wireless.

3. A method according to claim 1, wherein said network is the Internet

4. A method according to claim 1, wherein said network comprises a mobile telephone.

5. A method according to claim 1, wherein said network address is a URL website address.

6. A method according to claim 1, wherein said advertisement object comprises information that an advertiser wants to advertise.

7. A method according to claim 1, wherein said advertisement object comprises information relating to an advertised good or service.

8. A method according to claim 1, further comprising the following step:
transmitting to said user said network address corresponding to said guide code transmitted by said user.

9. A method according to claim 1, further comprising the following step:
providing a benefit to said user who transmits said guide code.

10. A method according to claim 1, further comprising the following step:
transmitting an identity code identifying said user.

11. A method according to claim 7, further comprising the following step:
allowing said user to purchase said advertised good or service by inputting said guide code.

12. A method according to claim 7, further comprising the following step:
transmitting an identity code identifying said user; and
allowing said user to purchase said advertised good or service by inputting said guide code.

13. A method according to claim 4, where in said advertisement object comprises information relating to a specific advertised good or service, further comprising the following step:
allowing said user to purchase said advertised good or service;
charging the cost of said purchase of said advertised item to a calling account of said mobile telephone.

14. An advertisement apparatus on a network, comprising:
means for displaying a guide code corresponding to a network address of an advertisement object;
means for allowing a user to transmit said guide code.

15. A computer program stored on a computer-readable medium, comprising the instructions of:
displaying a guide code corresponding to a network address of an advertisement object;
allowing a user to transmit said guide code.

16. An advertisement guide method using guide codes, comprising the steps of:
assigning guide codes respectively to each advertiser or each item of the advertiser, each of said guide codes being linked with the Web site of the advertiser or the item;
upon perceiving a given one of said guide codes, allowing a user to gain access to a guide code server through a mobile communication service system using his or her mobile communication terminal and to enter the given guide code in said terminal under the guidance of an automatic response service system;
when said given guide code is entered, searching a guide code database for Web site address information corresponding to the entered guide code and sending the searched Web site address information to a voice mail box belonging to a telephone number of said mobile communication terminal of the user; and
allowing said user to open said voice mail box associated with the telephone number of his or her mobile communication terminal, extracting information stored in said voice mail box and confirming a Web address of an advertising site corresponding to said given guide code on the basis of the extracted information.

17. An advertisement guide method using guide codes according to claim 16, wherein by assigning unique numerals to the guide codes of each advertiser and each item of the advertiser, the guide codes function as a transaction code for the advertiser or its items.

18. An advertisement guide method using guide codes according to claim 16, wherein a service associated with said voice mail box includes a short-message mail box.

19. An advertisement guide method using guide codes according to claim 16, wherein said step allowing access to guide server further comprises the following step:
allowing said user to enter the telephone number of his or her mobile communication terminal when he or she enters said given guide code.

20. An advertisement guide method using guide codes according to claim 18, wherein said step allowing access to guide server further comprises the following step:
allowing said user to enter the telephone number of his or her mobile communication terminal when he or she enters said given guide code.

21. An advertisement guide method using guide codes according to claim 16, wherein said step allowing access to guide server further comprises the following step:
allowing said user to enter the telephone number of a mobile communication terminal of third party when he or she enters said given guide code.

22. An advertisement guide method using guide codes according to claim 18, wherein said step allowing access to guide server further comprises the following step:
allowing said user to enter the telephone number of a mobile communication terminal of third party when he or she enters said given guide code.

23. An advertisement guide method using guide codes according to claim 16, wherein said step allowing access to guide server further comprises the following steps:
determining whether said user enters an automatic membership joining identifier when he or she enters said given guide code;
sending guide code membership information stored in a guide code membership database to said advertising site corresponding to said given guide code; and
automatically executing a membership joining procedure on the basis of the sent guide code membership information.

24. An advertisement guide method using guide codes according to claim 16, further comprising following step:
allowing said user to check a voice message stored in said voice mail box of said mobile communication terminal, confirming the Web address of the advertising site corresponding to said given guide code on the basis of the checked voice message, gaining access to the corresponding advertising site using his or her user personal computer and shift to a membership joining menu to execute a complimentary service-conditioned membership joining procedure.

25. An advertisement guide method using guide codes according to claim 22, wherein said complimentary service includes a predetermined amount of mobile communication terminal free-call time.

26. An advertisement guide method using guide codes according to claim 22, wherein said thank-you service includes offering of a predetermined amount of money and other valuables.

27. An advertisement guide system using guide codes, comprising:
at least one mobile communication terminal connected to a mobile communication service system over a radio communication network;
an automatic response service system connected to said mobile communication service system for sending guide code entry guide information to said mobile communication terminal in a mode of entering a specific one of the guide codes, inserted in a given advertisement, using said mobile communication terminal;
a guide code database for storing information about Web addresses of advertising sites of advertisers;
a server for extracting information about a Web address of an advertising site of an advertiser corresponding to said specific guide code from said guide code database when a user enters information containing said specific guide code using said mobile communication terminal under the guidance of said automatic response service system and then generating short-message information based on the extracted Web site address information; and
a mail box service system connected to said mobile communication service system for storing said short-message information from said server in a mail box belonging to a telephone number of said mobile communication terminal and reproducing the stored short-message information for user's confirmation.

28. An advertisement guide system according to claim 27, wherein said server includes a guide code membership database for providing a one-click membership joining service to said user through a personal information pre-registration procedure.

29. An advertisement guide system according to claim 27, wherein said mail box service system includes a voice mail box service.

30. An advertisement guide system according to claim 27, wherein said server includes a membership joining complimentary service provision system for providing a predetermined amount of mobile communication terminal free-call time to said user on condition that said user registers as a member of the advertising site of the advertiser corresponding to said specific guide code.

31. A radio Internet access method using guide codes, comprising the steps of:
assigning the guide codes respectively to each advertiser or each item of the advertiser, each of said guide codes being linked with the Web site of the advertiser or the items of the merchandiser so that people can perceive the Web addresses of the advertising sites by corresponding guide codes;
allowing people to gain access to a guide code server through a gateway using his or her mobile communication terminal and enter a specific one of said guide codes in said terminal; and
when said specific guide code is entered, searching a guide code database for a Web address of an advertising site of an advertiser corresponding to the entered guide code and forwarding said mobile communication terminal to the searched Web site address.

32. A radio Internet access method according to claim 31, wherein each of said guide codes is appended with a given one of sub codes assigned respectively to items of goods being on sale in an advertising site of a corresponding one of said advertisers and then inserted and marked in a corresponding advertisement together with the given sub code, each of said sub codes being composed of numerals and being directly linked to a site selling an associated goods item, whereby said peoples gain direct access to a specific selling site by connecting to a radio Internet network using his or her mobile communication terminal and entering one of said sub codes corresponding to the specific selling site in said terminal.

33. A reservation, purchase and settlement system using guide codes, comprising the following steps:
charging a user for the purchased service or goods in combination with or separately from the telephone fees of a mobile communication terminal of said user, so as to secure anonymity and security of said user when he or she reserves or purchases a specific service or goods on the Internet using guide codes
